(19) United States
(12) Patent Application Publication
(10) Pub. No.: US 2009/0227698 A1
(43) Pub. Date: Sep. 10, 2009

(54) Varnish For The Surface Coating Of Shaped Articles

(76) Inventors: Dietmar Votteler, Korntal-Muenchingen (DE); Wolfgang Nowotny, Korntal-Muenchingen (DE); Joerg Sentko, Korntal-Muenchingen (DE)

Correspondence Address: KRIEGSMAN & KRIEGSMAN, 30 TURNPIKE ROAD, SUITE 9, SOUTHBOROUGH, MA, 01772, US

(21) Appl. No.: 12/225,150

(22) PCT Filed: Mar. 14, 2007
(86) PCT No.: PCT/EP2007/002249

§ 371 Date: May 14, 2009

(30) Foreign Application Priority Data
Mar. 15, 2006 (EP) 10 2006 012 274.7

(51) Int. Cl. C08F 2/50; C08F 2/46; C08J 3/28

(52) U.S. Cl. 522/39; 522/104; 522/173; 522/100; 522/33; 522/46; 522/68; 522/64

(57) ABSTRACT

The invention concerns a surface coating for moulded articles, especially for the automotive industry, for use in IMC processes, said surface coating comprising at least 40% by weight of one or more resin components to achieve the requisite product properties, up to 60% by weight of one or more reactive diluents and between 0.3% and 1.5% by weight of UV initiators, the viscosity of the surface coating at the processing temperature being between 500 and 2500 mPa s; and also the use of a surface coating for coating moulded articles of wood in an IMC machine under UV irradiation.

The present invention relates to a varnish for the surface coating of shaped articles.

Coated shaped articles, for example comprising wood, wood-base materials, plastic, fiber composite materials (MDF, HDF, WPC), are frequently used for the interior trim of motor vehicles. In particular, shaped wood articles which may be in the form of solid parts or veneered parts are used here.

As a rule, a transparent varnish or resin layer is applied to the visible side of the shaped wood article in order to produce a hard-wearing and scratch-resistant, frequently glossy surface.

The requirements of the automotive industry with respect to the properties of these resin/varnish layers are high:

The VOC emissions of the cured varnish film must fulfill the corresponding specifications of the automotive industry, in respect of the OEMs (original equipment manufacturer), e.g. in the case of DaimlerChrysler less than 100 ppm VOC (90° C.), less than 80 ppm FOG (120° C.), test method e.g. VDA 278 (thermal desorption analysis), or corresponding specifications, e.g. of BMW or VW.

The surface hardness (microhardness, Martens hardness), which is to be determined on the basis of DIN EN ISO 14577 (force increase 0.1-1000 mN, t=60 s), should be from 80 to 140 N/mm², since problem-free grinding, polishing and milling are possible in this range.

Furthermore, the coatings must be scratch-resistant, i.e. must fulfill the corresponding automotive standards with regard to the scratch resistance (crockmeter test or mar resistance test). In the case of DaimlerChrysler, the mar resistance must be above 9 newton, and above 100 double strokes in the crockmeter test.

Further requirements regarding the cured varnish are the degree of yellowing and the UV stability. The degree of yellowing of the cured varnish film is assessed according to corresponding tests, such as thermal cycling, storage at high temperature, storage in a conditioned atmosphere, which are specified by the automotive industry, on the basis of the gray scale according to ISO 105-A02, it being necessary for the gray scale to correspond to at least level 4.

With regard to the UV stability, varnish material and coated substrate, after appropriate exposures to light, are tested for color changes using the specifications required by the automobile manufacturers and are assessed on the basis of the gray scale according to ISO 105-A02, it being necessary for the gray scale to correspond to at least level 4.

If the varnish is applied by means of in-mold coating, good demoldability of the coated and cured material from the mold surface is furthermore required, preferably without additional release agents being required.

A further important criterion is the transparency of the varnish film, i.e. the cured varnish film, after curing or after corresponding stress (heat, exposure to light, climate), should not have any haze and should show no visible changes compared with the load-free reference part (state on delivery).

Furthermore, the casting material should have as little shrinkage as possible so that absolutely no warpage of the component results. Of course, in the case of collision of the motor vehicle, furthermore no varnish particles should be detached or flake off, i.e. no flying particles should result.

As a rule, the varnishes are sprayed onto or applied to the surface to be coated. It is also known that the coating material can be applied by means of injection molding.

US2004/0152799 A1 discloses a flexible radiation-curable formulation which serves for imprinting or coating of injection-molded polycarbonate or other thermoplastics. The formulation comprising resin components and reactive diluents is applied to the plastic material by multi-layer printing, i.e. in succession in a plurality of thin layers. These UV-curable formulations which serve for imprinting thermoplastics in thin layers all have a proportion of at least 4% by weight of UV initiators. In general, the thickness of such layers is about 5 to 25 μm. As materials to be coated, thermoplastics are completely different from wood, simply because of the different surface energies and adhesion, the large differences in water absorptivity, shrinkage and swelling behavior and the solvent resistance.

Furthermore, it is known that shaped wood articles can be coated by means of in-mold coating (IMC). For this purpose, the shaped wood article is placed in the cavity of a mold part, a gap being formed between the surface of the shaped wood article to be coated and the wall of the mold part, into which gap the liquid surface coating material is introduced. By filling the mold, a large part of the air or optionally other gases or gas mixtures is displaced from the gap. The coating material present in the cavity is substantially sealed in the mold from corresponding contact with the atmosphere. The surface coating material is then cured within the gap, for which—as described in DE 43 20 893 C1 and DE 199 61 992 A1—UV radiation can be used. For this purpose, the shaped article is formed so as to be transparent to UV radiation, preferably at least in the region of the surface to be coated. The height of the gap which corresponds to the thickness of the varnish layer produced, is in general about 300 μm-1000 μm.

In the in-mold coating, the total layer is applied in a single operation.

UV-curable coating materials comprise a resin component and a UV initiator. By means of UV irradiation, the UV initiator forms free radicals which initiate a chain reaction which is subsequently maintained even when there is no longer any irradiation. The surface coating material activated by means of UV radiation can then cure in the mold within a few minutes, for example less than 3 minutes, at least to such an extent that the interior trim part provided with the surface layer can be released from the mold part and can be handled.

The complete curing can be effected in the mold or outside the mold, optionally with UV or electron irradiation.

The prior art discloses UV-curable spray or casting varnishes which have viscosities of less than 300 mpa.s. To enable any crosslinking at all to be achieved with these UV-curable varnishes, the UV varnishes used have a UV initiator content of at least 2% by weight, depending on their applied layer thickness.

During the use of these formulations for coating shaped wood articles in the molds of the IMC process in internal investigations at the applicant's premises, however, considerable emissions of VOCs were observed after UV irradiation, and in some cases the varnishes tended to yellow and moreover there was insufficient curing of the varnish layers throughout.

The object of the present invention is to provide a UV-curable varnish for coating shaped wood articles by means of the IMC process, which, on exposure to UV irradiation in an IMC mold, in particular in the case of a gap width of about 300-1000 μm, preferably of 700 to 900 μm, cures sufficiently throughout and whose VOC emission is as low as possible. Of course, this varnish should also meet the other requirements of the automotive industry, in particular should be transparent, and crack-resistant and should have surface scratch resistance and show only very little tendency to yellowing.

Surprisingly, it was found that sufficient curing of the UV-curable resins throughout in IMC molds can be achieved by reducing the proportion of UV initiators in the formulation to less than 1.5% by weight. The UV-curable varnish according to the invention thus has at least 40% by weight of one or more resin components for establishing the required product properties, up to 60% by weight of one or more reactive diluents and from 0.3 to 1.5% by weight of UV initiators.

The resin components can be selected from the group consisting of the unsaturated polyester resins, the acrylate or methacrylate prepolymers or oligomers, the polyurethane-polyester prepolymers and mixtures thereof.

The unsaturated polyester resins are preferably those based on maleic acid, fumaric acid, mesaconic acid, citraconic acid, itaconic acid, o-phthalic acid, isophthalic acid, terephthalic acid, tetrahydrophthalic acid, adipic acid, succinic acid and/or sebacic acid or the anhydrides thereof.

The acrylate or methacrylate prepolymers or oligomers are preferably selected from the group consisting of the UV-reactive and/or electron beam-curable epoxy acrylates, polyester acrylates, urethane acrylates, polyol acrylates, polyether acrylates or the mixed prepolymers of these classes of compounds.

The resin type or types used is or are selected according to the requirements which the cured varnish has to meet.

Preferably, the proportion of the resin component or components in the varnish is from 45 to 90% by weight and—depending on the respective resin component and the reactive diluent—particularly preferably from 50 to 70% by weight.

The reactive diluents are preferably selected from the group consisting of the vinylic monomers, such as, for example, styrene or vinyltoluene, and the mono-, bi- and polyfunctional acrylates and methacrylates, which include, for example, the compounds hexanediol diacrylate, hydroxymethylethyl acrylate, hydroxyethyl acrylate, hydroxypropyl acrylate, hydroxyethyl methacrylate, hydroxypropyl methacrylate, polyethylene glycol diacrylate, trimethylolpropane triacrylate, trimethylolpropane trimethacrylate, dipropylene glycol diacrylate, tripropylene glycol diacrylate, 2-(hydroxymethyl) methacrylate, butanediol dimethacrylate, triethylene glycol dimethacrylate and isobornyl methacrylate.

The choice of the respective reactive diluents depends on the respective resin component(s) and on the required product properties.

Furthermore, the varnishes according to the invention comprise UV initiators, which are preferably selected from the group consisting of the α-hydroxyketones, benzophenone, phenyl glyoxylates, benzyl dimethyl ketals, α-aminoketones, monoacylphosphines (MAPO), bisacylphosphines (BAPO) and phosphine oxides and mixtures thereof. Mixtures of UV initiators which have proven particularly useful are those comprising hydroxyketones and/or MAPO and/or BAPO.

A proportion of UV initiators in the resin of less than 1.2% by weight and in particular from 0.5 to 1.0% by weight is preferred.

The varnish according to the invention may furthermore comprise customary varnish additives, such as UV absorbers, HALS (hindered amine light stabilizers), additives based on nanoparticles, flameproofing agents, surface-active substances and internal lubricants, preferably in a proportion of 0 to 3% by weight, it being possible for the proportion to be up to 30% by weight in the case of nanoparticles and flameproofing agents.

To enable processing by means of the IMC processes, the viscosity of the varnish according to the invention at 20° C. is from 500 to 2500 mPa·s (measured according to DIN 53019). If the IMC process is to be carried out at an elevated temperature of the varnish, which temperature must of course be adapted to the varnish system, the viscosity at the processing temperature should be from 500 to 2500 mPa·s. Preferably the viscosity of the varnish at 20° C. or at the processing temperature in the IMC unit is from 700 to 1000 mPa·s.

Within the scope of the present invention, it was also found that a varnish which comprises at least 40% by weight of one or more resin components for establishing the required product properties and up to 60% by weight of one or more reactive diluents, the viscosity of the varnish at the processing temperature being from 500 to 2500 mPa·s, can also be used in IMC processes in which the curing is effected by means of electron irradiation. UV initiators are not required in this case. In the case of the electron beam-cured varnishes, too, the specifications of the automotive industry which were explained above are fulfilled, the varnishes have surface hardnesses of at least 80 N/mm², the VOC emissions are below the limits of the manufacturers. The mar resistance is above 9 N, and more than 100 double strokes are achieved in the crockmeter test. With regard to the degree of yellowing and the UV stability, too, gray scales of at least level 4 are achieved.

The invention is described in more detail below with reference to example formulations and comparative experiments.

### 1ST EXAMPLE FORMULATION

98.9% of polymerizable substance, the polymerizable substance consisting of 69.0% by weight of a mixture of highly resilient and viscoplastic unsaturated polyester resin bodies and 31% by weight of styrene as reactive diluent

1.1% of UV initiator of the MAPO type

### 2ND EXAMPLE FORMULATION

99.11% of polymerizable substance, consisting of a mixture of highly resilient and viscoplastic unsaturated polyester resin bodies (69%) and 31% of reactive diluent (styrene)

0.17% by weight of UV initiator of the MAPO type

0.72% by weight of UV initiator of the BAPO type

### 3RD EXAMPLE FORMULATION

99.4% of polymerizable substance, the polymerizable substance consisting of 49.4% of epoxy acrylate and 50.6% of reactive diluent mixture comprising HDDA (hexanediol diacrylate), HEMA (hydroxyethylene methacrylate), isobornyl acrylate and tripropylene diacrylate

0.4% by weight of UV initiator of the MAPO type

0.2% by weight of UV initiator of the phenyl glyoxylate type

For example Irgacure TPO from Ciba Specialty Chemicals is suitable as a UV initiator of the MAPO type, for example Irgacure 819 from Ciba Specialty Chemicals is suitable as a UV initiator of the BAPO type and, for example, Darocur MBF from Ciba Specialty Chemicals is suitable as a UV initiator of the phenyl glyoxylate type.

Table 1 lists the further example formulations and the results of measurements which were obtained after coating and UV curing of the varnish in an IMC unit.

All comparative experiments A to R were carried with the same UV resin mixture in order to be able to assess the surface hardness, emission values and the coating result as a function of the amount and the type of initiator.

The UV initiator of type 1 was of the MAPO type, that of type 2 was of the BAPO type and that of type 3 was of the phosphine oxide type.

The evaluation of the coating result was effected qualitatively taking into account the scratch resistance, appearance, the degree of yellowing, the demoldability and possible bubble formation.

The results of the experiments show that, in the case of a varnish layer applied in a thick layer of about 800 μm in a single coating process in an IMC unit, high emissions are achieved at the high UV initiator content of 2.5% by weight known from the prior art and also at a very low UV initiator content of 0.3% by weight, and that good to very good coating results and low VOC emissions and good surface hardness are obtained at an initiator content of from 0.3 to 1.5% by weight, in particular from 0.5 to 1% by weight.

TABLE 1
Comparative examples

| Experimental arrangement | A | B | C | D | E | F | G | H | I |
|---|---|---|---|---|---|---|---|---|---|
| UP resin mixture | 98.9 | 98.9 | 99.7 | 99.7 | 98.9 | 98.9 | 99.3 | 99.3 | 98.9 |
| UV initiator 1 | | | | | 0.55 | 0.55 | 0.35 | 0.35 | 1.1 |
| UV initiator 2 | 1.1 | | 0.3 | | 0.55 | | 0.35 | | |
| UV initiator 3 | | 1.1 | | 0.3 | | 0.55 | | 0.35 | |
| Surface hardness [N/mm²] | 120.4 | 124.1 | 115.7 | 110.2 | 123.3 | 129.5 | 125.2 | 123.1 | 124.4 |
| TDSA VOC* | 813 | 296 | 948 | 3082 | 97 | 218 | 520 | 403 | 221 |
| Coating result | − | +/− | + | + | +/− | +/− | + | +/− | − |
| Overall evaluation | − | + | − | − | + | +/− | − | +/− | − |

| Experimental arrangement | J | K | L | M | N | O | P | Q | R |
|---|---|---|---|---|---|---|---|---|---|
| UP resin mixture | 99.7 | 99.3 | 99.3 | 99.1 | 99.3 | 99.1 | 99.1 | 99.1 | 97.5 |
| UV initiator 1 | 0.3 | | | 0.17 | 0.7 | 0.72 | 0.17 | 0.72 | 1.25 |
| UV initiator 2 | | 0.7 | | 0.72 | | 0.17 | | | 1.25 |
| UV initiator 3 | | | 0.7 | | | | 0.72 | 0.17 | |
| Surface hardness [N/mm²] | 104.2 | 123.5 | 120.8 | 124.3 | 118.9 | 122.6 | 124 | 124.7 | 149.2 |
| TDSA VOC* [ppm] | 8846 | 202 | 287 | 82 | 331 | 194 | 259 | 154 | 16732 |
| Coating result | + | − | − | + | − | − | − | − | − |
| Overall evaluation | − | − | − | + | − | − | − | − | − |

*TDSA = thermal desorption analysis according to VDA 278

1. A varnish for the surface coating of shaped articles, in particular for the automotive industry, for use in IMC processes, which varnish comprises at least 40% by weight of one or more resin components for establishing the required product properties, up to 60% by weight of one or more reactive diluents and from 0.3 to 1.5% by weight of UV initiators, the viscosity of the varnish at the processing temperature being from 500 to 2500 mPa·s.

2. The varnish as claimed in claim 1, characterized in that resin components are selected from the group consisting of the unsaturated polyester resins, the acrylate or methacrylate prepolymers or oligomers, the polyurethane-polyester prepolymers and mixtures thereof.

3. The varnish as claimed in claim 1, characterized in that the unsaturated polyester resins are those based on maleic acid, fumaric acid, mesaconic acid, citraconic acid, itaconic acid, o-phthalic aicd, isophthalic acid, terephthalic acid, tetrahydrophthalic acid, adipic acid, succinic acid and/or sebacic acid or the anhydrides thereof.

4. The varnish as claimed in claim 1, characterized in that the acrylate or methacrylate prepolymers or oligomers are selected from the group consisting of the UV-reactive and/or electron beam-curable epoxy acrylates, polyester acrylates, urethane acrylates, polyol acrylates, polyether acrylates or the desired prepolymers of these classes of compounds.

5. The varnish as claimed in claim 1, characterized in that reactive diluents are selected from the group consisting of the vinylic monomers and the mono-, bi- and polyfunctional acrylates and methacrylates and in particular are styrene, vinyltoluene, hexanediol diacrylate, hydroxymethylethyl acrylate, hydroxyethyl acrylate, hydroxypropyl acrylate, hydroxyethylene methacrylate, hydroxypropyl methacrylate, polyethylene glycol diacrylate, trimethylolpropane triacrylate, trimethylolpropane trimethacrylate, dipropylene glycol diacrylate, tripropylene glycol diacrylate, 2-(hydroxymethyl) methacrylate, butanediol dimethacrylate, triethylene glycol dimethacrylate and/or isobornyl methacrylate.

6. The varnish as claimed in claim 1, characterized in that the UV initiators are selected from the group consisting of the α-hydroxyketones, benzophenone, phenyl glyoxylates, benzyl dimethyl ketals, α-aminoketones, monoacylphosphines (MAPO), bisacylphosphines (BAPO) and phosphine oxides and mixtures thereof.

7. The varnish as claimed in claim 1, characterized in that the proportion of UV initiators is less than 1.2% by weight and in particular from 0.5% to 1.0% by weight.

8. The varnish as claimed in claim 1, characterized in that, after UV irradiation of the varnish layer applied to the shaped article in the mold and curing, the surface hardness is at least 80 N/mm² (force increase 0.1-1000 mN, t=60 s).

9. The varnish as claimed in claim 1, characterized in that, after UV irradiation of the varnish layer applied to the shaped article in the mold and curing, the mar resistance is above 9 N and/or more than 100 double strokes are achieved in the crockmeter test.

10. The varnish as claimed in claim 1, characterized in that the VOC emission of the cured varnish film is less than 100 ppm VOC (at 90° C.) and/or less than 80 ppm FOG (at 120° C.).

11. The use of a varnish as claimed in claim 1 for the coating of shaped wood articles in an IMC unit with UV irradiation.

12. The use of a varnish as claimed in claim 11 for the production of a coating in a single operation with a layer thickness of from 300 to 1000 μm.

13. A varnish for the surface coating of shaped articles, in particular for the automotive industry, for use in IMC processes, the curing of the varnish being effected by means of electron irradiation, which varnish comprises at least 40% by weight of one or more resin components for establishing the required product properties and up to 60% by weight of one or more reactive diluents, the viscosity of the varnish at the processing temperature being from 500 to 2500 mPa·s.
